(19) United States
(12) Patent Application Publication
(10) Pub. No.: US 2013/0311271 A1
(43) Pub. Date: Nov. 21, 2013

(54) STRUCTURED RELEVANT KEYWORD AND INTENT SUGGESTION WITH BID AND OTHER AUCTION PARAMETERS BASED ON ADVERTISER SPECIFIC CONTEXT

(71) Applicants: RAHUL AGRAWAL, BANGLORE (IN); MEHULKUMAR PARSANA, BANGLORE (IN)

(72) Inventors: RAHUL AGRAWAL, BANGLORE (IN); MEHULKUMAR PARSANA, BANGLORE (IN)

(73) Assignee: MICROSOFT CORPORATION, REDMOND, WA (US)

(21) Appl. No.: 13/473,947

(22) Filed: May 17, 2012

(51) Int. Cl. G06Q 30/02

(52) U.S. Cl. 705/14.45; 705/14.71

(57) ABSTRACT

Systems, computer-readable media, and methods for suggesting intents and bids for the suggested intents to a user are provided. The user may have an advertising campaign that includes one or more words. An advertisement system is configured to suggest intents and bids for intents. The intents are represented by a bundle of keywords. The advertisement system suggests bundles having similar intents to the one or more words associated with the user. A graphical user interface displays the bundles and allows the user to modify the keywords and bids. The graphical user interface is also updated with statistics associated with the bundles or keywords in the bundle.

### BACKGROUND

Conventional advertisement auction systems allow advertisers to bid on keywords. Based on the bids received, the advertisement system renders an appropriate advertisement to a client that is viewing content associated with the keyword. Also, the advertisements may be rendered to the client that enters a search query having the keyword. The advertisements may be included in a search engine result page (SERP). The advertisements may be associated with the advertisers that bid the most pay to have particular search term combinations return the SERP. The advertisements may include images, links, or text. The advertisers typically pay for placement of the advertisement on a per-click basis. The total charge for the placement of the advertisement in the SERP may be based on, among other things, the number of times a client clicks on the link associated with the advertisement.

The conventional advertisement auctioning systems allow the advertisers to build and manage advertisement campaigns. The advertisement auctioning system displays keywords to the advertisers. The advertisers review the keywords, which may be thousands of words, and manually select keywords relevant to advertisements of the advertisers. In turn, the advertisement auctioning system includes the selected keywords in the advertisement campaign.

To improve advertiser experience, some conventional advertisement auctioning systems provide broad matching for keywords to at least partially mitigate some aspects of the complexity associated with keyword matching and selection. Generally, broad matching means that when advertisers bid on a keyword using a broad match option, a search engine may apply a bid for a particular keyword to a broader set of keywords, such as keywords that may be deemed to be semantically or linguistically related to that particular keyword.

### SUMMARY

Embodiments of the invention relate to systems and methods for suggesting intents for keywords and bids associated with the suggested intents. The advertisement auction system creates bundles based on query logs maintained by a search engine. The advertisement auction system calculates a similarity between the keywords in the query log. The keywords that are similar are grouped together in the bundle. The bundles are associated with advertisers based on the intents shared by the one or more words received from the user and the bundle. The one or more words may be extracted from the advertisement campaigns of the advertisers.

In some embodiments, the advertisers provide the advertisement auction system with a query having one or more words. In turn, the advertisement auction system identifies an intent associated with the one or more words. A graphical user interface presents bundles having matching intents. In one embodiment, the bundles include a suggested bid price. The graphical user interface is configured by the advertisement auction system to receive advertiser modifications. The modifications may include indications to remove or add one or more keywords. The modifications may include a desired bid amount for the bundle. Additionally, the modifications may include a desired bid amount for the one or more keywords in the bundle.

Embodiments of the invention are defined by the claims below, not this Summary. A high-level overview of various aspects of embodiments of the invention are provided here for that reason, to provide an overview of the disclosure, and to introduce a selection of concepts that are further described below. This Summary is not intended to identify key features or essential features of the claimed subject matter, nor is it intended to be used in isolation to determine the scope of the claimed subject matter.

### BRIEF DESCRIPTION OF THE SEVERAL VIEWS OF THE DRAWINGS

Illustrative embodiments of the invention are described in detail below with reference to the attached drawing figures, which are incorporated by reference in their entirety and wherein:

FIG. 1 is a network diagram that illustrates an exemplary computing system in accordance with embodiments of the invention;

FIG. 2 is a component diagram illustrating an exemplary advertisement auction system, in accordance with embodiments of the invention;

FIG. 3 is a logic diagram illustrating an exemplary computer-implemented method to return keywords based on intents associated with one or more words corresponding to advertisers in accordance with embodiment of the invention;

FIG. 4 is another logic diagram illustrating an exemplary computer-implemented method to organize keywords into bundles in accordance with embodiment of the invention; and

FIG. 5 is a graphical user interface illustrating bundles displayed in response to advertiser input associated with an advertisement in accordance with embodiment of the invention.

### DETAILED DESCRIPTION

The subject matter of this patent is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step,” “block,” and/or “component,” etc., might be used herein to connote different components of methods or systems employed, the terms should not be interpreted as implying any particular order among or between various steps herein disclosed unless and except when the order of individual steps is explicitly described.

As used herein, natural user interface (NUI) may be defined as any interface technology that enables a user, advertiser or searcher, to interact with a graphical user interface of a computing device in a “natural” manner, free from artificial constraints imposed by input devices such as mice, keyboards, remote controls, and the like.

The advertisement auction system bundles keywords for advertisers that are building or maintaining advertisement campaigns. The bundles include suggested bid prices and statistics like impressions, clicks, and demographics associated with the keywords. The demographics include, among other things, age, gender, and location. In one embodiment, the keywords within the bundle may share common attributes. The common attributes may include: bid amount; target criteria like age, gender, or location; advertisement copies, landing pages, etc. The automatic generation of these bundles by the advertisement auction system saves the advertisers from manually creating or maintaining advertisement campaigns and manually selecting individual keywords and corresponding bids for the advertisement campaigns. The automatically created bundles may be viewed in a graphical user interface that groups bundles into various intents. The graphical user interface in some embodiments is configured as a NUI.

In another embodiment, the advertisement auction system populates an index with the keywords from the query log of a search engine. The keywords are organized into bundles using a bundle identifier. In one embodiment, the bundle identifier may be an intent associated with keywords in the bundle. In some embodiments, a graphical user interface displays the intents associated with each bundle in a common display area. Advertisers interact with the graphical user interface to expand on the keywords included in a selected bundle.

The bundles, in certain embodiments, are stored in an index, which provide a data structure that organizes the keywords. The index provides advertisers with insights into the intents that correspond with the keywords. In one embodiment, the index may be utilized to suggest relevant intents for one or more words received from the advertisers. Additionally, the bundles allow the advertisers to bid on the entire bundle (all keywords) to simplify the bidding process.

The advertiser may interact with the graphical user interface to modify the configuration of the bundle. For instance, the advertiser may alter suggested keywords by adding or removing keywords. The advertiser may, also, alter suggested bids for the entire bundle or keywords within the bundle. In certain embodiments, the graphical user interface provides statistics that summarize the keywords currently included in the bundle. In one embodiment, as new terms or keywords are added to query log, the bundles may be updated to include the new words in the query log. The bids associated with the bundle corresponding to the new keyword may be applied to the new keyword or a user may separately specify a bid for the new keyword. The graphical user interface may include aggregate statistics based on individual statistics for the keywords in the bundle. The statistics provide the advertiser with an overview of the bundles utility within the advertiser's advertisement campaigns.

Various aspects of the technology described herein are generally directed to computer systems, computer-implemented methods, and computer-readable storage media for, among other things, returning keywords bundles to advertisers that provide one or more keywords to an advertisement auction system. The bundles represent intents and each keyword within the bundle corresponds to the intent represented by the bundle. Embodiments of the invention allow the advertisement auction system to suggest bundles and bids to the one or more words received from the advertiser. In some embodiment, the one or more words are extracted from an advertisement campaign associated with the advertiser.

As one skilled in the art will appreciate, the computer system may include hardware, firmware, software, or a combination of hardware and software. The hardware includes processors and memories configured to execute instructions stored in the memories. The logic associate with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows the advertisement auction system to generate the bundles and suggested bids based on the data stored in the query logs. The computer system may include a search engine and the query logs that store search queries. The query logs may be stored in the memory of the computer system. The query logs are accessible by the advertisement auction system, which is configured to generate the bundles and suggested bids for the bundles.

In one embodiment, the memories of the computer system include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating within the computer system. By way of example, and not limitation, computer-readable media comprise computer-storage media and communications media. Computer-storage media, or machine-readable media, include media implemented in any method or technology for storing information on a memory device. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In yet another embodiment, the computer system includes a communication network having a database, client computers, and a server. The database is configured to store bundles and suggested bids for the bundles of keywords. A user may provide one or more words at the client computer, which is communicatively connected to the server. The server may operate an advertisement auction system that generates bundles and retrieves bundles based on the input received from the client computer. In turn, the computer may display the bundles to the user of the client computer. The user may enter modifications to suggested bundles and bids that may be stored in the database. Accordingly, a search engine may select the most appropriate advertisement based on intent similarity between the bundles stored in the database and the one or more words or the advertising campaign associated with the user.

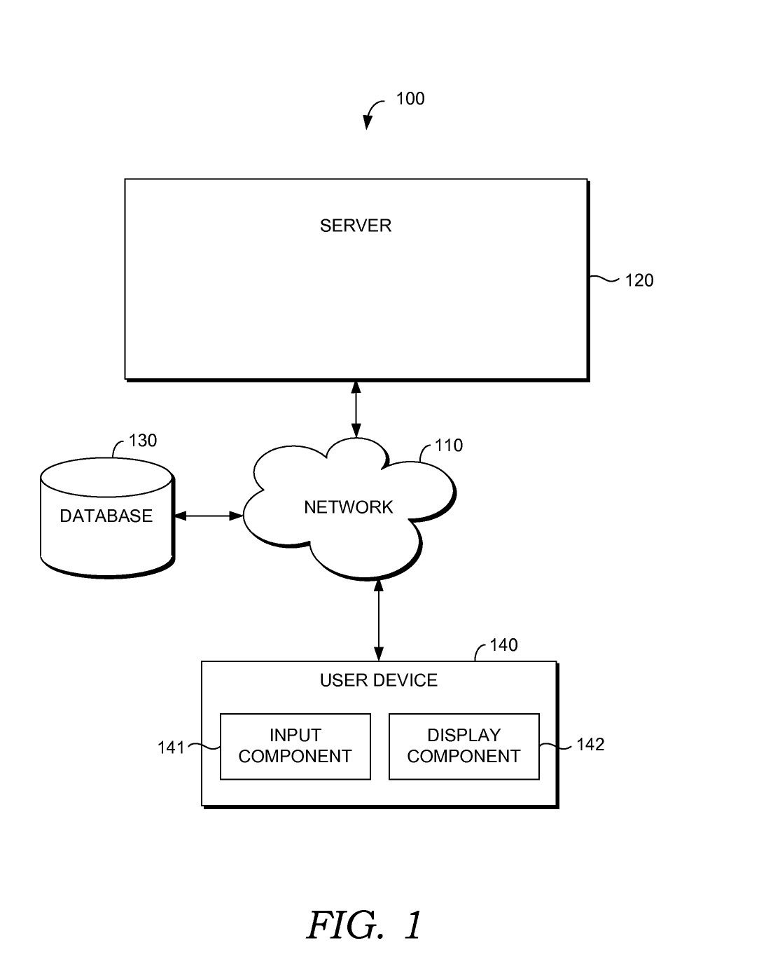

FIG. 1 is a network diagram that illustrates an exemplary computing system in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a network 110, server 120, database 130, and user device 140 that receives the suggested bundles and suggested bids from an advertisement auction system executing on the server 120.

The network 110 enables communication among the various network devices and resources. The network 110 connects server 120 and database 130. The network 110 also connects the user device 140 to the server 120 and database 130. The network 110 is configured to facilitate communication between the user device 140 and the server 120. It also enables a search engine (not shown) to obtain advertisements based on search queries received by the search engine or uniform resource locators (URLs) in a search engine results page. The server 120 may communicate the advertisements over the network 110 to the search engine upon receiving the search queries received by the search engine or the search result generated by the search engine. The network 110 may be a communication network, such as a wireless network, satellite network, local area network, wired network, or the Internet. In an embodiment, the user device 140 interacts with the search engine utilizing the network 110. For instance, a searcher of the user device 140 may provide the search queries to the search engine. In response, the search engine generated a SERP by interrogating a search index stored in database 130 for URLs that include web pages, images, videos, or other electronic documents that match the search queries generated by the searcher. The advertisements that match the search queries or the content associated with the URLS are displayed in the SERP.

The server 120 maintains the advertisement campaigns. The sever 120 is connected to the network 110 and stores the information associated with the advertisement campaigns in the database 130. The advertisement campaigns include keyword bundles and bids selected by the user. The server 120 utilizes the advertisement campaigns to provide advertisements to a search engine that receives the search queries. The server 120 executes an advertisement auction system to select an advertisement in response to a search query. In some embodiments, the advertisement selected by the advertisement auction system maximizes revenue generated for the server 120. The advertisement auction system transmits the selected advertisements via network 110 to the user device 140, which display the advertisements to the user. In certain embodiments, the advertisement auction system provides the advertisement to the SERP.

In certain embodiments, the advertisement auction system tracks advertisement requests, navigation of advertisements, and keywords to maintain counts associated with number times a keyword is submitted, number of times an advertisement is clicked, and advertisement view frequency. The counts maintained by the advertisement auction system may be used to rank the advertisements. In one embodiment, the advertisement auction system may use the counts to identify a most popular advertisement.

The database 130 stores the advertisement campaigns, including advertisements and corresponding statistics. In some embodiments, the advertisements are banner advertisements, display advertisements, text, images, animations, graphics, contextual advertisements, search advertisements, radio advertisements, mobile advertisements, television advertisements, or print advertisements that describe a good, service or thing that an advertiser wishes to promote to users. The things described in the advertisements may include events and items from all over the world, from various merchants, and from various distributors. The statistics include dwell time, impressions, bid amount, clicks, etc. In an embodiment, the database 130 stores keyword bundles generated from query logs. The advertisements are retrieved from the database 130 and transmitted in response to requests received from the search engine or advertisement auction system. The database 130 may organize the advertisements based on advertiser, brand, goods, or services. The database 130 may store attributes for each advertisement. The attributes include, but are not limited to, click, cost, keywords, bundle identifier, etc. The database 130 is populated based on campaigns selected by the advertisers and keyword bundles created from the query logs. In some embodiments, the database 130 is automatically or manually populated with the advertisements and corresponding statistics.

The user device 140 allows the searcher to view a SERP received from the search engine. In some embodiments, the search engine results page includes advertisements that correspond to the results in the SERP. The user device 140 is connected to the search engine via network 110. The user device 140 is utilized by a user to generate search queries, to hover over objects, to select links or objects, and to receive search engine results pages or web pages that are relevant to the search terms, the selected links, or the selected objects. The user device 140 includes, without limitation, personal digital assistants, tablets, smart phones, laptops, personal computers, gaming systems, set-top boxes, or any other suitable client computing device. Accordingly, the user device 140 may range from full resource devices with large storage capacity and processing power, e.g., personal computers and game consoles, to a low-resource device with small storage capacity and few processing resources, e.g., traditional set-top boxes and hand-held game consoles. In some embodiments, the user device 140 obtain user consent to monitor or track location information, browsing activity, and demographic information. The consent includes, among other things, permission to process the user's biometric information or gestures detected by the user device 140.

In one embodiment, the user device 140 includes user and system information storage that stores searcher and system information on the user device 140. The searcher information may include search histories, cookies, and passwords. The system information may include Internet Protocol addresses, cached web pages, and system utilization. The user device 140 communicates with the search engine to receive the search results or web pages that are relevant to the search queries, the selected links, or the selected objects. The user device 140 may communicate with the server 120 to receive advertisements related to the search query. The advertisements may be received directly from database 130 or proxied by way of the server 120. For instance, upon receiving a query including the word “car” from the user device 140, the server 120 may provide one or more advertisements that include related items like insurance, mechanics, or dealerships.

In some embodiments, the searcher may interact with the user device 140 through a controller, such as, a stylus, a keyboard and a mouse, or a natural user interface (NUI). The NUI includes air gestures, voice, or other physiological inputs generated by the searcher. These inputs may be interpreted as search queries by the user device 140, which transmits the search queries. Alternatively, the user device 140 may provide the inputs received by the user device 140 directly to the search engine. The NUI implements any combination of speech recognition, touch and stylus recognition, facial recognition, biometric recognition, gesture recognition both on screen and adjacent to the screen, air gestures, head and eye tracking, and touch recognition associated with displays on the user device 140. The user device 140 is equipped with depth cameras, such as, stereoscopic camera systems, infrared camera systems, RGB camera systems, and combinations of these for gesture detection and recognition. Additionally, the user device 140 may be equipped with accelerometers or gyroscopes that enable detection of motion. The output of the accelerometers or gyroscopes is provided to the display of the user device 140 to render immersive augmented reality or virtual reality.

The user device 140 is configured to receive one or more inputs via touch interaction with a hardware component, such as a screen or other controller of the user device 140. Touch interaction may involve pressing a button, moving a joystick, movement across a track pad, use of a touch screen of the user device 140 (e.g., detection of a finger or a stylus), and so on. Recognition of the touch inputs may be leveraged by user device 140 to interact with a user interface of applications, e.g., search, media, editing, gaming, etc. executing on the user device 140.

As disused above, the natural user interface may recognize non-touch interactions. For example, the user device 140 may be configured to recognize audio inputs through use of a microphone. For instance, the user device 140 may execute voice recognition to recognize particular utterances (e.g., a spoken command) or to recognize a particular searcher that provided the utterances. In another example, the user device is configured to recognize gestures, presented objects, images, and so on through use of cameras.

In some embodiments, an advertiser may utilize an end-user device 140 to manage the advertisement campaigns. The advertiser may connect to server 120 and create or edit the keywords and bids for the advertisement campaigns. Accordingly, the advertiser may interact with the advertisement campaign via the server 120.

Accordingly, the computing system 100 is configured with a server 120 that provides advertisements based on content viewed or requested by a searcher. The search query generated by the user device 140 is received by the search engine, which provide results, including matching advertisements obtained from server 120. The search engine transmits the results to the user device 140. In turn, the user device 140 renders the results for the searchers.

Embodiments of the invention provide keyword bundles to assist with managing advertisement campaigns. The advertisement auction system includes a bundle generator component and a bundle retrieval component. The bundle generator component forms keyword bundles from the query logs associated with a search engine. The keyword bundles are stored in storage for use when managing the advertisement campaign. An advertiser associated with an advertisement campaign may view keyword bundles that have a similar intent with the one or more words in the advertisement campaign. Additionally, advertisers without advertisement campaigns may view keyword bundles having similar intents to one or more word provided to the advertisement auction system when creating an advertisement campaign. The matching keyword bundles are retrieved and rendered for display.

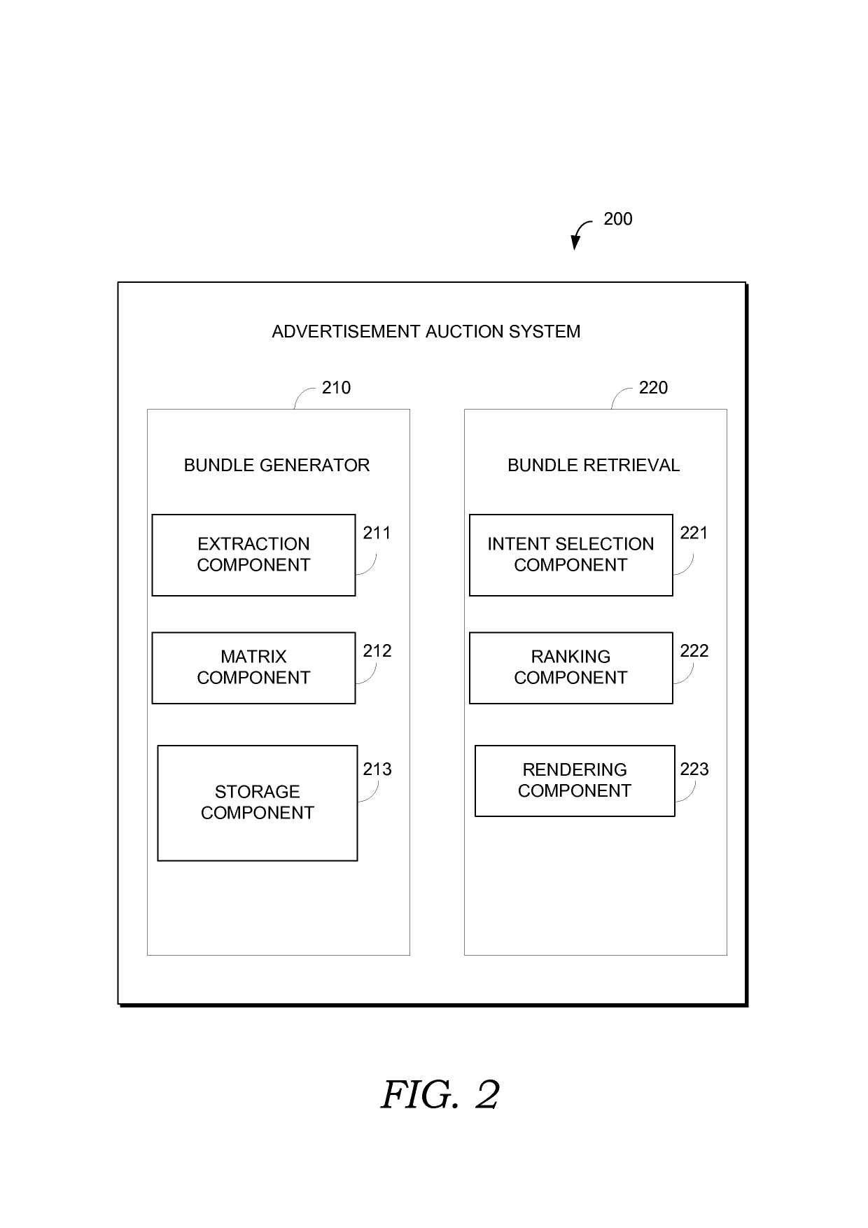

FIG. 2 is a component diagram illustrating an exemplary advertisement auction system 200, in accordance with embodiments of the invention. The advertisement auction system 200 includes a bundle generator component 210 and bundle retrieval component 220. The bundle generator component 210 bundles keywords based on similarity. The bundle retrieval component 220 obtains the keyword bundles and renders the keywords bundles using intent similarity between the bundles and the advertisement campaign or one or more words provided by an advertiser.

The bundle generator component 210 includes an extraction 211, matrix component 212, and storage component 213. The extraction component 211 accesses a query log and extracts keywords from the query log. The extraction component 211 may identify the keywords in the query log based on frequency within the query log. In some embodiment, the keywords may be identified based on interaction statistics, like click or hover statistics. Alternatively, the keywords may be identified based on location or frequency within the content containing the keywords. The extraction component 211 may parse the content to determine location and frequency for the words. For instance, a word in the title, header, or anchor may be identified as a keyword. Also, words that appear frequently in the content may be identified as keywords. The extraction component 211 extracts the identified keywords from the query log and transmit the keywords to the matrix component 212.

The matrix component 212 receives the keywords from the extraction component 211. In turn, the matrix component 212 calculates keyword-keyword similarity for each keyword in the similarity. The keyword similarity may be determined from a machine learning model that considers keyword overlap, click logs, and advertiser bid logs. The number of clicks and advertiser bids may indicate similarity when timestamp attribute provides co-occurrence metrics for each keyword. The machine learning model may include supervised machine learning models like multiple additive regression trees or support vector machines.

In some embodiments, the matrix component populates a 2×2 matrix. The scores calculated for keyword-keyword similarity may be stored in the matrix. For instance, the matrix may be represented as the following.

| | K1 | K2 | K3 | K4 | KN |
|---|---|---|---|---|---|
| K1 | 1 | .8 | 0 | .6 | 0 |
| K2 | .8 | 1 | .1 | 0 | .3 |
| K3 | 0 | .1 | 1 | 0 | 0 |
| K4 | .6 | 0 | 0 | 1 | .8 |
| KN | 0 | .3 | 0 | .8 | 1 |

The similarity between each keyword is stored in the matrix which is factored into two separate matrixes. The two separate matrices include intent vectors that are used to calculate the current matrix formed by the matrix component 212. In other words, the current matrix K×K=[K×I]×[I×K].

$$\begin{matrix} & {K}_{1} & {K}_{2} & {K}_{n} \\ {K}_{1} & 1 & .8 & 0 \\ {K}_{2} & .8 & 1 & .3 \\ {K}_{n} & 0 & .3 & 1\end{matrix} = \begin{matrix} & {I}_{1} & {I}_{2} & {I}_{n} \\ {K}_{1} & 1 & 0 & 0 \\ {K}_{2} & .8 & .2 & .4 \\ {K}_{n} & .1 & .4 & 0\end{matrix} \times \begin{matrix} & {K}_{1} & {K}_{2} & {K}_{n} \\ {I}_{1} & 1 & .8 & .1 \\ {I}_{2} & 0 & .2 & .4 \\ {I}_{n} & 0 & .4 & 0\end{matrix}$$

Accordingly, the matrix K×K provides the constrains for the intent vectors (I). The intent vectors represent the keyword bundles that are generated by the advertisement action system 200. In some embodiments, the intent vectors comprise keywords above a specific similarity threshold, e.g., 0.2. The vectors I₁=|K₁:1 and K₂:0.8| and I₂=|Kₙ=0.4| include the keyword and similarity in a data structure, e.g., list or array, that is stored by the storage component 213. The vectors identify intents and corresponding keywords located in the query log.

The matrix factorization performed by matrix component 212 allows the advertisement auction system to calculate the probabilities associated with several keyword combinations. For example, the matrix component 212 calculates the following:

$$P ( {K}_{a} , {K}_{b} ) = {\sum }_{I} P ( I ) P ( {K}_{a} \vert I ) P ( {K}_{b} \vert I ) .$$

In some embodiments, this probability, P(Kₐ,K_{b}), may be used to order the keywords in the intent vectors that are stored in the storage component 213. In some embodiments, the matrix component 212 is able to calculate both P(Kₐ|I) and P(I|Kₐ) from the keyword similarity scores generated for the keywords in the query logs. These calculated probabilities are stored in the storage component 213.

The storage component may format the bundles in several formats. In one format the keywords, suggested keywords, and intents are stored together in each record of the storage component. For instance, the keywords may stored in the following structure: <Keyword> [<SuggestedKeyword0, intent: similarity score, intent: similarity score, . . . >, <SuggestKeyword1, intent: similarity score, intent: similarity score . . . > . . . ]. Thus, a keyword like “new car 2012” may have the following bundle structure: <new car 2012> [<new compact cars, I₁:0.8, I₄:0.5, I₈:0.3,> <car deals, I₁:0.5 and I₈:0.4,> <accessories, . . . > <insurance . . . >]

As described above, the bundle generator component 210 processes the query log to bundle keywords. For instance, the bundle generator component 210 may identify “new car” as a keyword and bundle the following relevant keywords “new car prices,” “car quotes,” “car insurance for new car,” “accessories for new car,” “used car,” and “car polish” in an order based on the probabilities or similarity scores calculated by the matrix component 212.

The bundle retrieval component 220 includes an intent selection component 221, ranking component 222, and rendering component 223. The intent selection component 221 identifies an intent associated with one or more words provided by an advertiser when creating or managing an advertisement campaign. The one or more words may be extracted from a current advertisement campaign associated with the advertiser. Alternatively, the one or more words may be extracted from an input that the advertiser provides to the advertisement auction system 200. The intent selection component 221 classifies the input or advertisement campaign with one or more intents. The intents with the highest value for

$$P ( I \vert Campaign ) = {\sum }_{Keyword ∈ Campaign} P ( I \vert K )$$

are selected as intents for the advertisement campaign. In some embodiments, the words utilized in calculating P(I|Campaign) are the one or more words provided by the advertiser when creating a new campaign.

In turn, the intent selection component 221 may transmit the intents and the corresponding scores to the ranking component 222. The ranking component 222 orders the identified intents for the one or more keyword using P(I|Campaign). For each word in the advertisement campaign or for one or more words received to build the advertisement campaign, the following probability is determined: P(I|K). In turn, the corresponding intents are ordered based on the value of P(I|K). Each word associated with, or provided by, the advertiser is identified as word or campaign [I₁: P(I₁|K), Iₙ: P(Iₙ|K)] with the P(I|K) in descending order. In some embodiments, the storage component 213 may store the words or campaigns, rankings, and intents for each advertiser. For instance an advertiser may be building a campaign around [new cars] which has the following intents as the highest ranked intents {I₅, I₁, I₁₀}. When the advertiser is logged in to the advertisement auction system 200 and selects the [new cars] campaign, the previously stored intents may be retrieved and the corresponding keywords and associated bids may be rendered as suggestions to the advertiser. The suggested bids may be obtained from bid logs maintained by the advertisement auction system 200. The bid logs contain the previously successful bid for a corresponding keyword. For display to the advertiser, the keyword bundles retrieved for specific words or campaigns will be re-ranked using intent ranking of the campaign or one or more advertiser words with minimum shuffle in keyword based ranking.

In some embodiments, when the advertisement auction system 200 does not have any words or campaign from the advertiser, the advertisement auction system generate a generic ordering of intents based on the number of keywords associated with each bundle, e.g. intents. Once the advertiser, provides one or more words or logs in to an account associated with an advertisement campaign, the advertisement auction system calculates or obtains advertiser-specific rankings for the intents in the advertisement auction system. In several embodiments, the advertiser is allowed to bid on each intent, which enables the advertiser to bid on all keywords associated with the intent. Alternatively, the advertiser may bid on individual keywords within the intent and discard other keywords that are not of interest to the advertiser.

The advertiser specific rankings for the intents are provided to the rendering component 223. The ranking component 222 transmits these rankings and the corresponding intents to the rendering component 223. In at least one embodiment, the rendering component limits the number of ranked intents to n, where n is whole number greater than 2. For example, based on the calculations performed by the ranking component, the advertiser specific ranking associated with an advertisement campaign or one or more words received from the advertiser may be first: I₄, second: I₁, and third: I₂. In turn, the rendering component 223 retrieves the keywords that correspond to the ranked intents.

In one embodiment, the storage component 213 is be accessed by the rendering component 223 to obtain the keywords for the highest ranked intents. For each intent corresponding to the advertisement campaign or the one or more words, the keywords are displayed. In certain embodiments, the keywords within the bundles are ordered based on the previously calculated similarity score. The rendering component 223 may organize the bundles for each word associated with the advertiser as follows: word: <I₄, [keyword1, keyword5, . . . ]> <I₁, [keyword8, keyword12, . . . ]> and <I₂ [keyword1, keyword17, . . . ]>.

Accordingly, the advertisement auction system generated bundles of keywords that represent intents found within query logs. The bundles are utilized to suggest keywords to an advertiser that is building or maintain an advertisement campaign. In some embodiments, the bundles are ranked based on the probability that the intent of the advertiser is given the word in the advertisement campaign or the word provided by the advertiser. In some embodiments, the suggested keywords include suggested bids for the keywords. The advertiser is able to modify the keywords included in a bundle or a bundle bid suggested by the advertisement auction system.

In some embodiment, the advertisement auction system is configured to identify intents associated with an advertiser campaign or one or more words provided by an advertiser. The intents are utilized to obtain appropriate keyword suggestions for the advertiser. The keyword suggestions include bid suggestions for all keywords associated with identified intents or bid suggestions for individual keywords associated with the intent. The advertisement auction system may periodically update the bundles with new keywords located in the query logs. In one embodiment, the bid suggestions for the bundle are applied as the bid for the new keywords included in the bundles. In certain embodiments, the advertiser is allowed to modify the keywords included in the set associated with intent. Additionally, the advertiser may modify the bids associated with keywords.

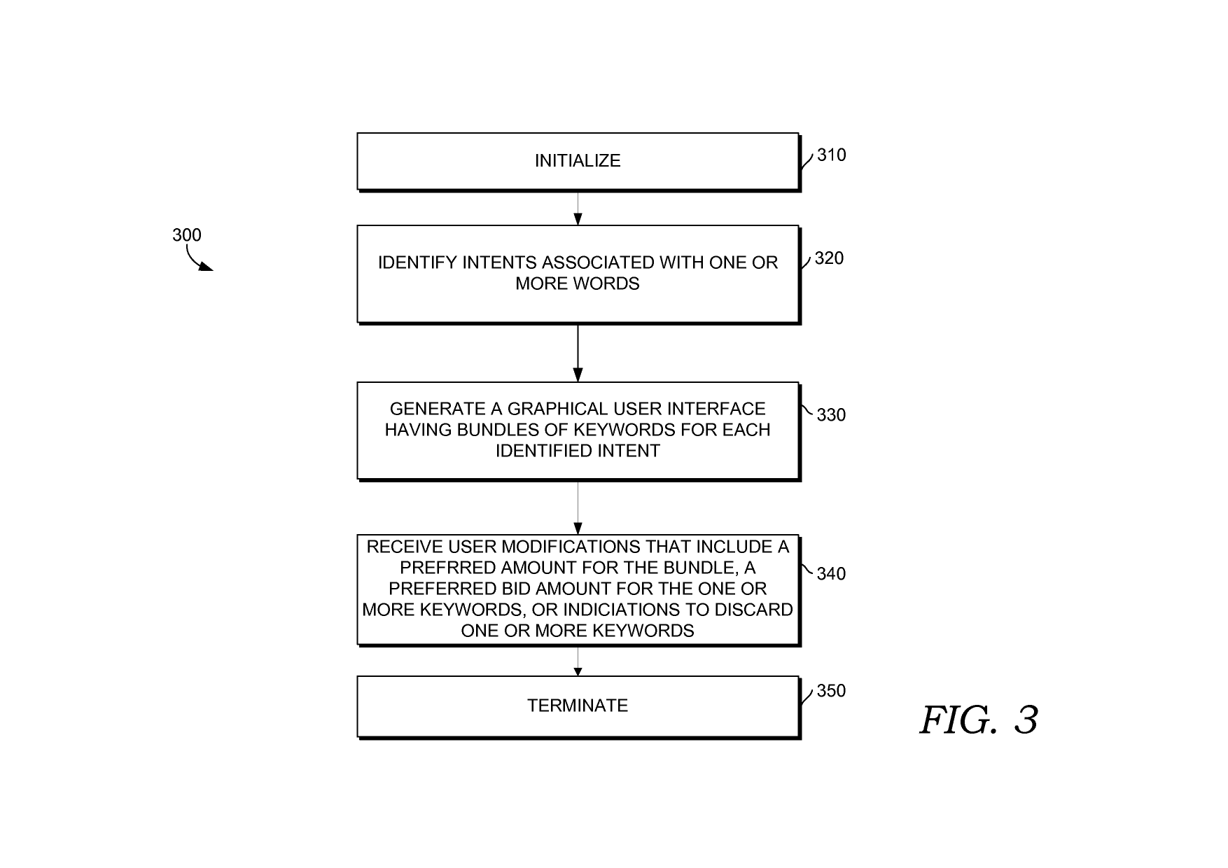

FIG. 3 is a logic diagram 300 illustrating an exemplary computer-implemented method to return keywords based on intents associated with one or more words corresponding to advertisers in accordance with embodiment of the invention. The method initializes, in step 310, when an advertiser accesses the advertisement auction system. In some embodiments, the advertiser accesses the system via a logs-in to the advertisement auction system that includes a security authentication protocol, e.g., username and password.

In step 320, the advertisement auction system identifies intents associated with the one or more words. The one or more words are extracted from an advertisement campaign associated with the user, in at least one embodiment. In turn, the graphical user interface having bundles of keywords for each identified intent is generated by the advertisement auction system, in step 330. The bundles include suggested bundle bid and suggested keyword bids. The bundles, in certain embodiments, are ranked based on similarity of intent among words in the advertisement campaign and the keywords associated with the bundles. The bundles may be displayed in rank order in the graphical user interface. The graphical user interface may display metrics like aggregated click and impression statistics for the bundle.

In step 340, the advertisement auction system receives user modifications that include a desired amount for the bundle bid, desired bid amounts for the one or more keywords in the bundle, or indications to discard one or more keywords. The metrics displayed in the graphical user interface are updated based on a modification that discards one or more keywords contained in the bundle or that adds one or more keywords to the bundle. The method terminates in step 350.

Accordingly, the advertisement campaign or one or more words received from an advertiser are matched to intents associated with the keyword bundles. The intents with the highest similarity or probability of matching are selected. For instance the top four intents are selected. In some embodiments, the top four intents per word associated with the advertiser, or received from the advertiser, are identified as potential matches. The bundles of keywords associated with the matching intents are retrieved and displayed to the advertiser.

In some embodiment, the bundles of keywords are created from query logs maintained by a search engine. The bundles may represent intents associated with the one or more keywords included in the bundles. Keywords may be represented in multiple bundles. The advertisement auction system may utilize a matrix factorization technique to identify the keywords for the each intent. The advertisement auction system considers query occurrence information, bid occurrence information, dwell time, and other metrics when selecting the keywords for the identified intents.

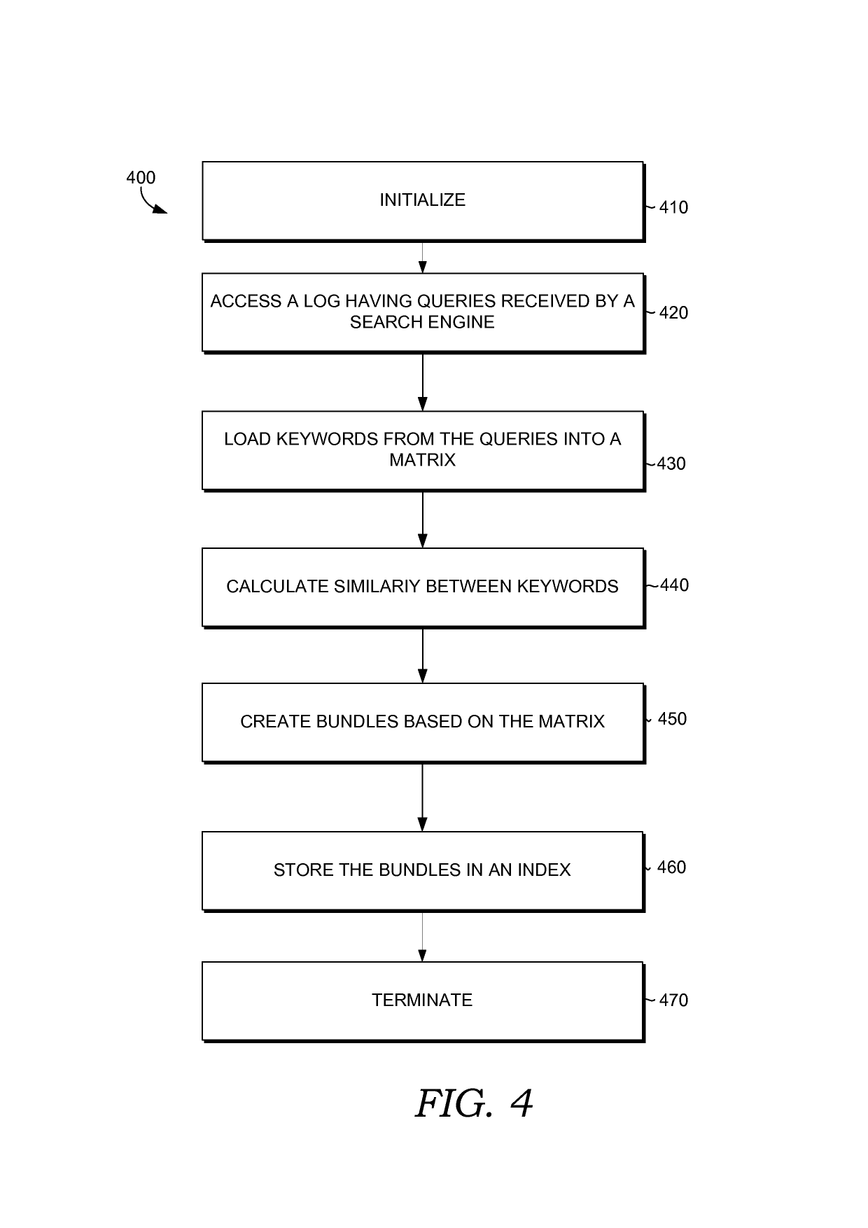

FIG. 4 is another logic diagram 400 illustrating an exemplary computer-implemented method to organize keywords into bundles in accordance with embodiment of the invention. The method initializes, in step 410, once the server executing the advertisement auction system is power on. The method may be executed periodically by the server. In step 420, the advertisement auction system accesses a log having queries received by a search engine. The advertisement auction system loads the keywords from the queries in the log into a matrix, in step 430. In turn, the advertisement auction system, in step 440, calculates similarity between the keywords and updates the matrix with similarity scores. The similarity between keywords stored in the log is based on, among other things, click statistics associated with the keywords. In another embodiment, the similarity between keywords stored in the log is based on bid statistics associated with the keywords.

In step 450, the advertisement auction system creates bundles based on the matrix. The bundles include similar keywords. In at least one embodiment, the bundles represent intents. The bundles are stored in an index by the advertisement auction system in step 460. The bundles are retrieved by the advertisement auction system from the index based on a word or phrase received from, or associated with, an advertiser.

The advertisement auction system renders for display the bundles based on similarity between the keywords in the bundle and the word or phrase received from the advertiser. The word or phrase may be extracted from an advertisement campaign associated with the advertiser. The intents associated with the word or phrase provided by the advertiser is determined by the advertisement auction system to select the corresponding bundles. In some embodiment, the bundles also include suggested bundle bids. The suggested bundle bids are aggregates of suggested keyword bids for each keyword in the bundle. The method terminates in step 470.

Accordingly, the bundles of keywords are created by the advertisement auction system based on the query logs and bid logs. The bundles include suggested keywords and suggested bids that aid the advertiser in maintaining or creating an advertisement campaign. The bundles are displayed in a graphical user interface along with various metrics, like impressions and clicks to allow the advertiser to select bids and keywords.

In some embodiments, the advertisement auction system is configured to provide a graphical user interface. The advertiser interacts with the graphical user interface to modify the bundles. The modifications may include removing keywords, adding keywords, updating bundle bids, or updating keyword bids. The bundles bids, in certain embodiment, allow the user to bid on all keyword with a similar bid price. For instance, the user may bid $1.00 USD for each keyword in the bundle. The bundle bid allows the system to automatically update the bundle to include new keywords corresponding to the intent associated with the bundle. The graphical user interface allows a user to select one or more intents associated with an existing advertisement campaign or one or more keywords received from the advertiser.

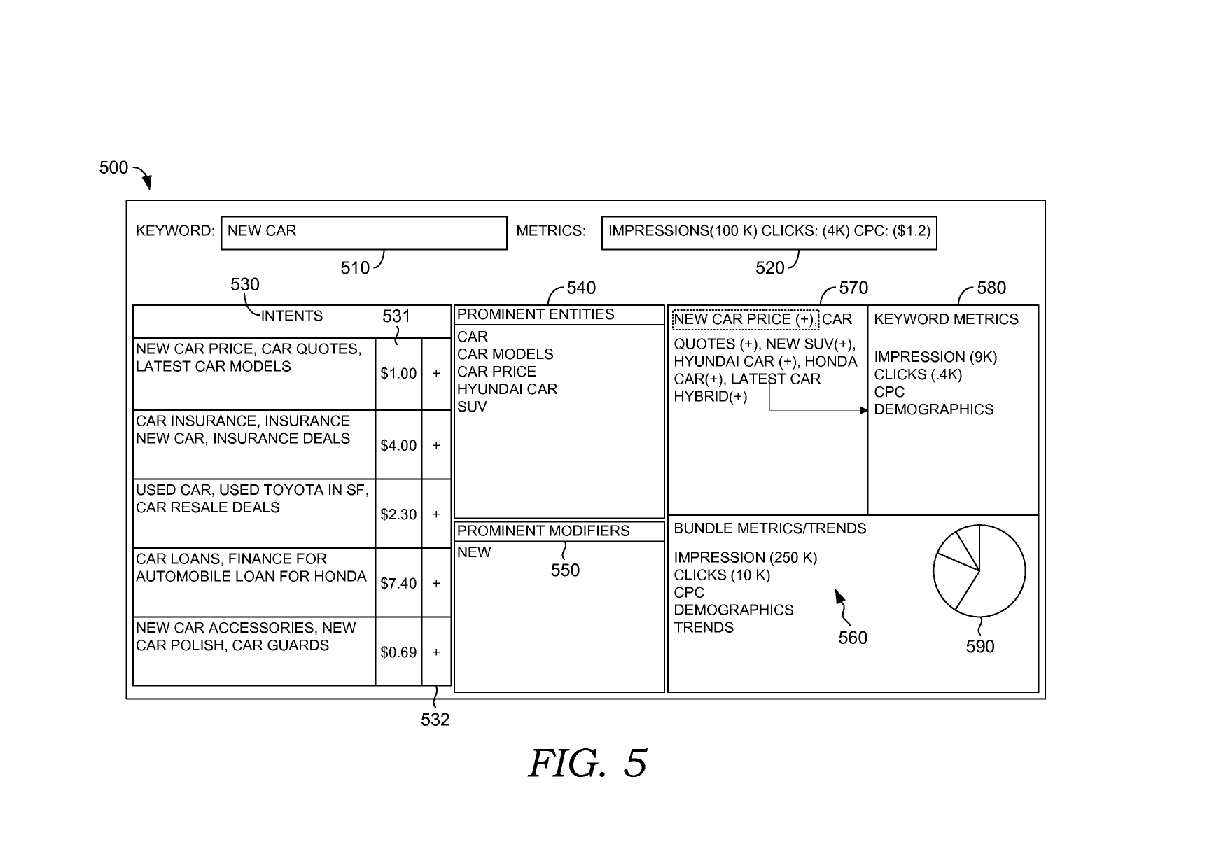

FIG. 5 is a graphical user interface illustrating bundles 530 displayed in response to advertiser input associated with an advertisement in accordance with embodiment of the invention. The bundles represent intents associated with an advertisement campaign or one or more words received from an advertiser. The bundles of keywords are generated from a query log associated with a search engine and are stored in a database. A server computer communicatively connected to the database may generate a graphical user interface 500 for building or maintain advertisement campaigns.

The graphical user interface 500 may include an input box 510 that receives one or more words. The words entered in the input box 510 may be received from an advertiser. In response to the words entered in the input box 510, the server may access bundles of keywords 530 stored in the database. The server updates the graphical user interface with metrics 520 associated with the one or more words. The metrics may include impressions, clicks, and cost-per-click. The server, in one embodiment, identifies intents associated with the one or more words entered in the input box and selects the one or more modifiable bundles of keywords based on the identified intents. Additionally, the server updates the graphical user interface 500 with one or more modifiable bundles of keywords 530 that are similar to the one or more words. The modifiable bundles include a bundle bid 531 and keyword bids (not shown). Selecting the “+” will allow the advertiser to view the suggested bids for bundle or for each keywords contained in the bundle. In some embodiment, the suggested bid may be provided from bid logs maintained by the advertisement auction system. The bid logs include amount that lead to successful display of advertisement or conversion to a sale. The advertiser may modify the suggested bids.

The graphical user interface generated by the server may identify prominent words included in the one or more modifiable bundles. The prominent words may include prominent entities 540 and prominent modifiers 550. Additionally, for each bundle selected by the advertiser, bundle trends 560 may be displayed. The trends include demographics, cost-per-click, clicks, impressions, and a graphical pie 590 that shows the geographic locations and the corresponding percentage of impression associated with the various geographic locations, e.g. mid-Atlantic, mid-west, northeast, etc.

The graphical user interface 500 may display each individual keyword in the detail section 570. The detail section may allow the advertiser to select, add, or remove keywords from the bundles. The advertiser may select the keyword to remove the keyword from the bundle. The advertiser may select the detail selection to add a new keyword that is not currently in the bundle.

For each keyword in detail section 570 hovered over by the advertiser, the graphical user interface may include keyword metrics 580. In some embodiment, the keyword metrics 580 are displayed when the keyword is selected by the advertiser. The keyword metrics include impressions, clicks, demographics, and cost-per-click.

The graphical user interface may be configured to be a natural user interface in at least one embodiment. It may be configured to receive a modification to the one or more modifiable bundles. In response to receiving the modification to the one or more modifiable bundles, the server removes or adds a keyword to the one or more modifiable bundles and updates the graphical user interface to display impression and click statistics for the selected keyword of the received modification.

Accordingly, the graphical user interface is configured to receive the advertiser input. In turn, graphical user interface provides various metrics associated with the advertiser input. The intents associate with the input are identified and displayed along with related to keywords. The advertiser may select one or more intents. In response to the user selection, the graphical user interface is updated with prominent entities that are present in the keywords associated with the intent and also the prominent modifiers. The prominent entities provide the advertiser with a quick snapshot of the dominant keywords. The graphical user interface also includes a keyword cloud that lists the actual keywords. In some embodiments, the font size is varied to indicate importance of the keyword. The importance of keywords is determined by the server based on impression, clicks, etc. The graphical user interface displays the keyword metrics when the advertiser hovers on a keyword in the keyword cloud. These metrics provide performance information for the keyword. Similarly, bundle metrics that are displayed in the graphical user interface provide the performance information for the whole bundle. There are “+” symbols adjacent the intents and the keywords allow the advertiser to depress “+” and enter in an appropriate bidding screen: bulk bid for whole intent having a suggested bundle bid or keyword bidding having a suggest keyword bid.

Embodiments of the invention generated keyword bundles and provide keyword bundles to advertisers that are maintaining or creating advertisement campaigns. The sever executing the advertisement auction system displays the keyword bundles and suggested bundle bids and keyword bids. The keyword bundles are displayed based on one or more words associated with, or received from, the advertiser. The advertiser is allowed to modify the keyword bundles to meet budget, geographic, or other targeting constraints. If the advertiser is not associated with, or does not provide, one or more words, then the graphical user interface is generated to display all intents identified in the query log for review by the advertiser.

The embodiments of the invention have been described in relation to particular embodiments, which are intended in all respects to be illustrative rather than restrictive. Alternative embodiments will become apparent to those of ordinary skill in the art to which the present invention pertains without departing from its scope. From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims. In other words, the patent has been described in language specific to structural features or methodological acts, it is to be understood that the subject matter defined in the appended claims is not necessarily limited to the specific features or acts described above. Rather, the specific features and acts described above are disclosed as example forms of implementing the claims.

The technology claimed is:

1. A computer-implemented method to organize keywords into bundles, the method comprising:
accessing a log having queries received by a search engine;
loading keywords from the queries in the log into a matrix;
calculating similarity between the keywords and updating the matrix with similarity scores;
creating bundles based on the matrix, wherein the bundles include similar keywords;
storing the bundles in an index;
retrieving the bundles from the index based on a word or phrase received from a user;
displaying the bundles to the user based on similarity between the keywords in the bundle and the word received from the user or based on similarity between the keywords in the bundle and the phrase received from the user.

2. The computer-implemented method of claim 1, wherein the bundles represent intents.

3. The computer-implemented method of claim 1, wherein displaying the bundles also displays suggested bundle bids.

4. The computer-implemented method of claim 3, wherein suggested bundle bids are aggregates of suggested keyword bids for each keyword in the bundle.

5. The computer-implemented method of claim 1, wherein similarity between keywords stored in the log is based on click statistics associated with the keywords.

6. The computer-implemented method of claim 1, wherein similarity between keywords stored in the log is based on bid statistics associated with the keywords.

7. The computer-implemented method of claim 1, wherein displaying a bundle further includes determining intents associated with the word or phrase.

8. The computer-implemented method of claim 1, wherein the word or phrase is extracted from an advertisement campaign associated with the user.

9. One or more computer-readable media having computer-executable instructions embodied thereon for performing a method to return keywords based on intents associated with one or more words corresponding to a user, the method comprising:
identifying intents associated with the one or more words;
generating a graphical user interface having bundles of keywords for each identified intent, wherein the bundles include suggested bundle bid and suggested keyword bids; and
receiving user modifications that include a desired amount for the bundle bid, desired bid amounts for the one or more keywords in the bundle, or indications to discard one or more keywords.

10. The media of claim 9, wherein the one or more words are extracted from an advertisement campaign associated with the user.

11. The media of claim 10, wherein the bundles are ranked based on similarity of intent among words in the advertisement campaign and the keywords associated with the bundles.

12. The media of claim 11, wherein the bundles are displayed in rank order.

13. The media of claim 9, further comprising displaying metrics in the graphical user interface, wherein the metrics include aggregated click and impression statistics for the bundle.

14. The media of claim 9, wherein the metrics are updated based on a modification that discards one or more keywords contained in the bundle or that adds one or more keywords to the bundle.

15. A computer system that causes a display to present a graphical user interface, the computer system comprising:
a memory storing bundles of keywords generated from a query log associated with a search engine; and
a processor communicatively connected to the memory and configured to perform the following:
(1) providing a graphical user interface having an input box that receives one or more words,
(2) receiving words entered in the input box, and
(3) in response to the words entered in the input box, accessing bundles of keywords stored in the memory and updating the graphical user interface with one or more modifiable bundles of keywords that are similar to the one or more words.

16. The system of claim 15, further comprising: identifying prominent words included in the one or more modifiable bundles; and displaying impression and click statistics for the one or more modifiable bundles.

17. The system of claim 16, further comprising: receiving a modification to the one or more modifiable bundles; and in response to receiving the modification to the one or more modifiable bundles, removing a selected keyword from the one or more modifiable bundles and updating the graphical user interface to display impression and click statistics for the selected keyword of the received modification or adding a keyword to the one or more modifiable bundles and updating the graphical user interface to display impression and click statistics for the selected keyword of the received modification.

18. The system of claim 18, wherein the graphical user interface is configured to be a natural user interface.

19. The system of claim 18, wherein a bid price for the bundle is included in the graphical user interface.

20. The system of claim 18, further comprising: identifying intents associated with the one or more words entered in the input box; and selecting the one or more modifiable bundles of keywords based on the identified intents.
